(19) United States
(12) Patent Application Publication
(10) Pub. No.: US 2021/0256945 A1
(43) Pub. Date: Aug. 19, 2021

(54) NECK-MOUNTED STRINGED INSTRUMENT SUPPORT DEVICE

(71) Applicant: Andrew Micco, Midlothian, VA (US)

(72) Inventor: Andrew Micco, Midlothian, VA (US)

(73) Assignee: Andrew Micco, Midlothian, VA (US)

(21) Appl. No.: 17/176,883

(22) Filed: Feb. 16, 2021

Related U.S. Application Data
(60) Provisional application No. 62/977,372, filed on Feb. 16, 2020.

(51) Int. Cl. G10G 5/00; G10D 1/08

(52) U.S. Cl. CPC G10G 5/00; G10D 1/08

(57) ABSTRACT

A portable neck-mounted stringed instrument support that facilitates support of the instrument against a variety of surfaces. The device consists of a clamping portion formed of a flexible material configured for mounting to a neck of the stringed musical instrument for rigidly holding the neck of the stringed musical instrument prior to placing the stringed musical instrument against a resting surface, the clamping portion including an annular space formed therein for housing the neck of the stringed musical instrument, and having a protruding ridge formed therein configured to prevent the neck or stringed musical instrument from twisting when housed in the annular space, and two or more support legs connected to a rear of the clamping portion for stabilizing the stringed musical instrument against the resting surface. In some instances the portable neck-mounted string instrument support comprises a guitar stand.

### CROSS-REFERENCE TO RELATED APPLICATIONS

This application claims priority to U.S. Provisional Patent Application No. 62/977,372, filed on Feb. 16, 2020. The foregoing patent application is herein incorporated by reference in its entirety.

### FIELD OF INVENTION

The present invention relates to a support device which mounts to the neck of a stringed instrument in order to provide support and stability, particularly when the instrument is leaned against or placed on a surface.

### BACKGROUND

When they are not actively playing their stringed instruments, such as a guitar, musicians often look for a quick and easy place to set their instruments. As such, when not in use, musicians often rest their guitar, or other stringed instrument, on a nearby surface. More particularly, if an instrument stand is not immediately nearby, musicians are often tempted to simply rest their instrument against the nearest available surface. Unfortunately, the surface, which is often an amplifier, table, wall, or even the floor, is not suited to adequately support the instrument and prevent it from falling over or to provide adequate support. As such, this leaves the instrument vulnerable for being knocked, bumped, or falling if not laid down carefully and correctly. This can cause damage to the instrument.

Currently, there are a variety of musical instrument support devices on the market for use with guitars, basses, and the like. One such device is a stand that rests on the ground and supports the body and/or neck of the instrument. Another is a hanger device which is mounted to a wall and the guitar hangs from the device by a support that holds the guitar at the neck beneath the headstock. There are other devices that mount to an amplifier, tabletop, or other fixed object, and support the instrument by allowing the neck to rest against a cradle or holding it in place by a fixed clamping mechanism. All of these existing supports are dependent on the surface to which they are attached. Each requires a mechanism for mounting on the particular surface and as such is specifically adapted to only a single type of surface. Further, because so many require a mechanism for mounting the device to the surface, there is no solution for a portable support that attaches to the instrument itself and can support and stabilize the instrument against any surface, plane, or object.

### BRIEF DESCRIPTION

It is therefore an objective of some aspects of the present invention to provide a support device capable of being mounted on a neck of a stringed instrument so as to provide stabilization and support as the stringed instrument is leaned or placed on a surface.

The present invention provides a support and stabilizing device that attaches to the neck of the stringed musical instrument. The support device includes a clamping portion formed of a flexible material configured for mounting to a neck of the stringed musical instrument for rigidly holding the neck of the stringed musical instrument prior to placing the stringed musical instrument against a resting surface, the clamping portion including an annular space formed therein for housing the neck of the stringed musical instrument, and having a protruding ridge formed therein configured to prevent the neck or stringed musical instrument from twisting when housed in the annular space, and two or more support legs connected to a rear of the clamping portion for stabilizing the stringed musical instrument against the resting surface.

Another aspect of the invention is a guitar stand including a clamping portion formed of a flexible material configured for mounting to a neck of the stringed musical instrument for rigidly holding the neck of the stringed musical instrument prior to placing the guitar against a resting surface, the clamping portion including an annular space formed therein for housing the neck of the guitar having a protruding ridge formed therein configured to prevent the neck or guitar from twisting when housed in the annular space, and two or more support legs connected to a rear of the clamping portion for stabilizing the guitar against the resting surface.

As is described more fully below, with the device attached the instrument body can be set on the floor with the neck inclined to rest against a wall, a tabletop, an amplifier, or any other object or planar surface.

The device also allows the instrument to lay on the floor, or a tabletop, with the neck elevated. In addition to supporting an instrument when not in use, the device can serve an alternate function in this manner as an aid to support the neck while conducting repairs and/or maintenance to the instrument.

### BRIEF DESCRIPTION OF THE DRAWINGS

The inventive system is described below in more detail purely by way of example with the aid of concrete exemplary embodiments illustrated schematically in the drawings, further advantages of the invention also being examined. Identical elements are labelled with the same reference numerals in the figures. In detail:

FIG. 1 is a top perspective view of a neck-mounted instrument stand as an example of a support device configured to incorporate the principles of the invention;

FIG. 2 is a three-quarter perspective view of the neck-mounted instrument of FIG. 1;

FIG. 3 is a top view of the neck-mounted instrument of FIG. 1;

FIG. 4 is a top view showing the neck-mounting instrument of FIG. 1 grasping the neck profile of a guitar;

FIG. 5 is a side perspective view of the neck-mounted instrument of FIG. 1 in use attached to the neck of a guitar;

FIG. 6 is a front perspective view of the neck-mounted instrument of FIG. 1 supporting a guitar against an amplifier;

FIG. 7 is a three-quarter perspective view of the neck-mounted instrument of FIG. 1 supporting a guitar against a wall;

FIG. 8 is a top view of a second embodiment of the invention which incorporates a hinge and a spring to the jaws;

FIG. 9 is a rear view of the second embodiment of the invention;

FIG. 10 is a top perspective view of a neck-mounted instrument stand according to a third embodiment of the invention; and

FIG. 11 is a three-quarter perspective view of the neck-mounted instrument of FIG. 10.

### DETAILED DESCRIPTION

The following is a detailed description of illustrative embodiments of the present invention. As these embodiments of the present invention are described with reference to the aforementioned drawings, various modifications, or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention.

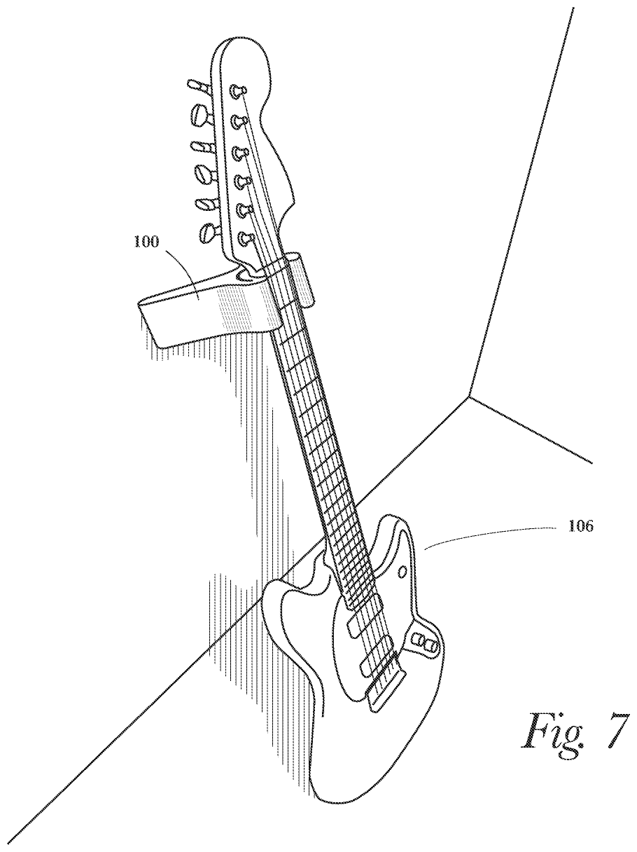

The present invention provides a stringed instrument support and stabilization device 100 which is positively attached to the neck 135 of a stringed instrument 106. Most commonly the instrument 106 to be supported is a guitar, as is shown in FIGS. 1-9, but is not limited to this, and may include any number of stringed instruments with a neck such as a bass, banjo, ukulele, or mandolin. As was briefly described above, most instrument stands or support devices are not physically attached to the instrument prior to attachment or interaction with the surface but rather such instrument stands are dependent upon an attachment to another surface, such as a floor or table in preparation for housing the instrument. Such stands or devices are limited in use by their fixed location or ability to only support the instrument against one type of surface. However, the neck-mounted instrument support device 100 of FIGS. 1-9 was designed specifically to positively attach only to the neck 135 of the instrument 106 and be used to support and stabilize it against any number of different surfaces, and to be compact and portable in nature. The support device 100 of the described embodiment shown in FIG. 1 has a set of flexible jaws 105 that grasp the neck 135 of a stringed instrument and has attached legs 101, or protruding wings, that stabilize the instrument 106 when leaned against a surface.

The support device 100 provides a new way to support or stabilize a stringed instrument 106 when not in use. The shape and the materials are crafted to provide a flexible yet stable grip; specifically, the jaws 105 of the device are shaped such that they can open and close around the neck of the instrument with minimal push or pull effort to engage it. The shape and material of the jaws 105 create a flexible spring-like hold on the neck 135 that applies inward pressure on the sides of the instrument's 106 neck 135 thus creating a friction fit that prevents slipping and twisting. As may be understood by one of skill in the art, the shape of the jaws 105 can open wider to accommodate necks of various sizes, widths, and shapes, or conversely, a variety of different support devices 100 may be developed with unique sizes and configurations so as to specifically fit to the neck 135 of corresponding unique devices. For example, a support device may be configured specifically for a ukulele, which typically has a smaller width neck than another stringed instrument, such as a steel stringed guitar, which in turn may have a smaller neck width than an acoustic guitar, classical or nylon string guitar, electric guitar, electric bass guitar, or six-string guitar.

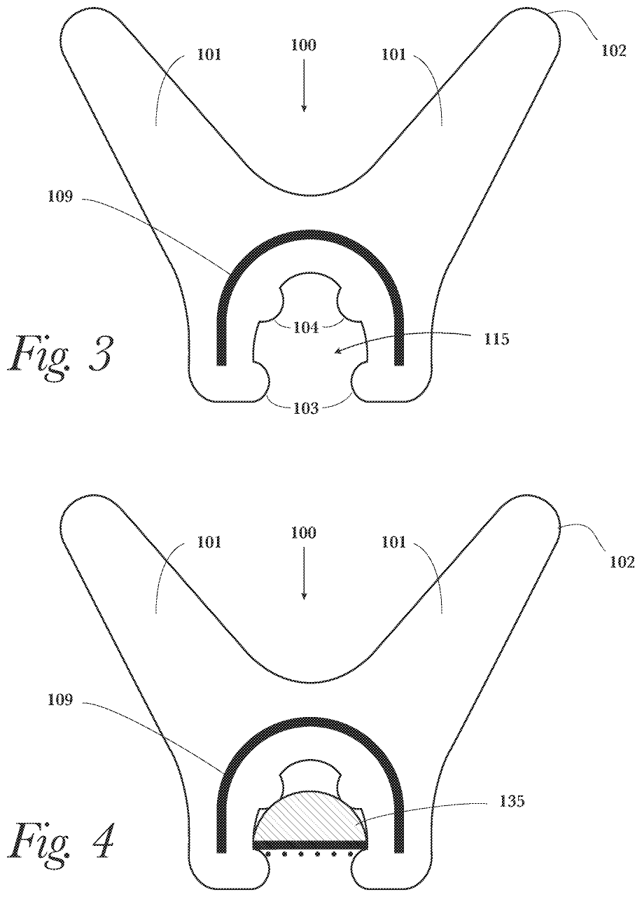

In this instance, the configuration of the support device 100 shown in FIG. 1 is configured to have a flexible jaw portion 105 as is described more fully below, so as to securely house and support a variety of different stringed instruments 106. The jaws 105 of the support device are shown more clearly in FIGS. 3-4. More particularly, the support device 100 has at least a pair of jaws 105 at an opposing surface of the support device 100 from the legs 101 which are configured to be placed against the surface on which the stringed instrument 106 and the attached support device 100 rests. The jaws 105 include a pair of rounded edges 103 at their terminus that together facilitate the insertion of a neck 135 of a guitar 106 or another stringed portion. The jaws 105 are configured such that when a pinching force is applied to the legs 101 or when a force is applied to the jaws 105 so as to urge each of the jaws 105 in opposite directions, the opening between the jaws 105 will become wider, permitting entry of the guitar neck 135 into the annular space 115 inside the jaws 105. Once the neck 135 is pushed past the rounded edge 103 and the force causing the jaws 105 apart is removed, the jaws 105 enclose around the neck 135, holding it firmly in place by applying pressure to the side edges and rear of the guitar neck 135 as is shown in FIG. 4.

In the configuration of the support device shown in FIGS. 1-9, there is a longitudinal ridge 104 running on the inside surface of each side of the jaws 105 which further provides support of the guitar neck 135 and helps prevent any twisting of the guitar neck 135 with respect to the support device 100 while the guitar neck 135 is disposed inside the annular space 115 formed between the jaws 105. As such, the inside surface of the jaws 105 where applied to the guitar neck 135 and the shape of the ends of the jaws 105 are thus uniquely shaped to grip the neck 135 firmly without allowing any twisting or slipping motion that could make the neck 135 disengage from the jaws 105. As may be understood, this assists in providing further support to the neck 135 as the guitar 106 and the attached support device 100 are placed against a surface and preventing any twisting force or slipping that could potentially otherwise occur.

Although in the embodiments described above the annular space 115 within the jaws 105 of the support device 100 is defined by an arced or “U” shape with the rounded edges 103 and the longitudinal ridges 104 formed thereon, it should be understood that a variety of different shapes may be used to define the interior surface between the jaws 105 so as to form the annular space 115 which houses and supports the neck 135 when attached thereto and the invention is not limited to the configuration illustrated in FIGS. 1-9. Rather, alternative shapes and configurations may be used, such as a “V” shape, a “C” shape, or others.

In addition, the support device 100 may also contain an inner “C” or “U” shaped spring clip 109, such as is shown in FIGS. 1-4 and 8-9, which provides structural support and resistance to deformation as is described below. In the embodiments shown in FIGS. 1-4, the spring clip 109 has a “C” shape and is disposed in a location so as to surround the circumference of the annular space 115 between the jaws 105, although the spring clip 109 could have another shape. In one preferred embodiment, the inner spring clip 109 is made of a stiffer material than the outer material of the jaws 105 and functions to provide supplemental clamping force against the neck 135 when the neck 135 is disposed within the annular space between the jaws 105. In one embodiment, the spring clip 109 could be made of plastic, metal, rubber, fiberglass, or other material of sufficient stiffness so as to provide resistance or an opposing force when forced open, such as when a force is applied to separate the jaws 105.

In another embodiment, the support device 100 as a whole may be made of a material which provides sufficient structural and resistive properties so that the spring clip 109 may be omitted. As such, in some instances, the support device 100 may function without this internal spring clip 109, provided that the material comprising the support device 100 is of sufficient strength and flexibility, such as a high durometer EVA foam, to provide the clamping force. On an opposite side of the support device 100 from the jaws 105, the legs 101 of the support device 100 protrude. The legs 101 of the support device 100 may or may not be made of the same material as the jaws 105. The legs 101 may be two or more extensions of cylindrical, rectangular, or other shaped protuberances, so long as they are sufficiently rigid enough to support the weight of the instrument 106 against a resting surface. The legs 101 may also include a curved, spherical, rounded, or other shaped end 102, or terminus, to allow continuous points of contact against the resting surface.

FIG. 1 is a top perspective view of the support device 100. The overall shape of the jaws 105 in this embodiment have a “U” shape, although as described above, the jaws 105 may form a variety of different shapes which create a spring-like force when the jaws 105 are pushed apart. The pair of longitudinal ridges 104 on the inside of the jaws 105 coupled with the rounded edges 103 of the jaws 105 provide a grip around the sides of the instrument's neck 135. The rounded edges 103 together provide a clamping and teeth-like function so as to engage with and assist in securing the neck 135 of the instrument 106 within the annular space 115. More specifically, the rounded edges 103 are able to slowly deform the jaws 105 and push them apart as a force is applied thereto, such as by the pressing of the neck 135 thereto, and enable the neck 135 to gently slide inside the jaws 105 and into the annular space 115 when pressed against them. The rounded edges 103 also prevents the instrument 106 from slipping out of the support device 100 when the jaws 105 are engaged around the neck 135.

The longitudinal ridge 104 is shaped to grasp the neck 135 while preventing it from twisting while secured by the jaws 105. The flexible material of the support device 100 allows the neck 135 to be released from the jaws 105 by gently twisting the neck 135 of the instrument 106 which forces the jaws 105 apart, while the rolled edge of the rounded edges 103 allows the neck 135 to easily slip out of the jaws 105.

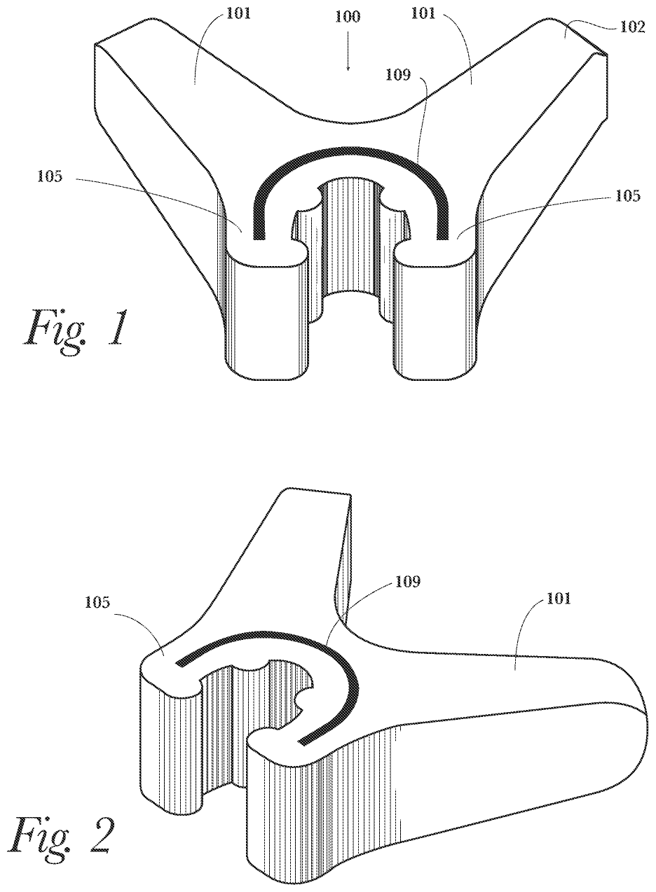

FIG. 2 is ¾ perspective view of the support device 100. As is more clearly shown in FIGS. 3-4, the support device 100 is symmetrical in relation to a vertical axis. The vertical height of the jaws 105 in this embodiment is approximately 2″ inches, though it could be less or more in another embodiment so long as the overall vertical height provides enough resistance to an overturning force created when the instrument 106 is resting at an angle to the ground.

FIG. 3 is a top view of the support device 100. The clear open width of the jaws 105 of the device are slightly less than the width of a guitar neck 135 near the nut. In a preferred embodiment, the flexible material of the support device 100 will allow the jaws 105 to open as wide as the width of a guitar 106 or bass guitar near the twelfth fret.

FIG. 4 is a top view of the support device 100 grasping the profile of a guitar neck 135. This view shows the shape of the jaws 105, which in this embodiment is a “C” or “U” shape, though in another embodiment could be any similar shape that creates spring-like force when the jaws 105 are pushed apart. The depth of the jaws 105 from front to back is approximately 1.75 inches in this embodiment but may be whatever depth that allows enough spring-like force to be applied to the neck 135 depending on the material being used, and that can accommodate common neck shapes of various instruments.

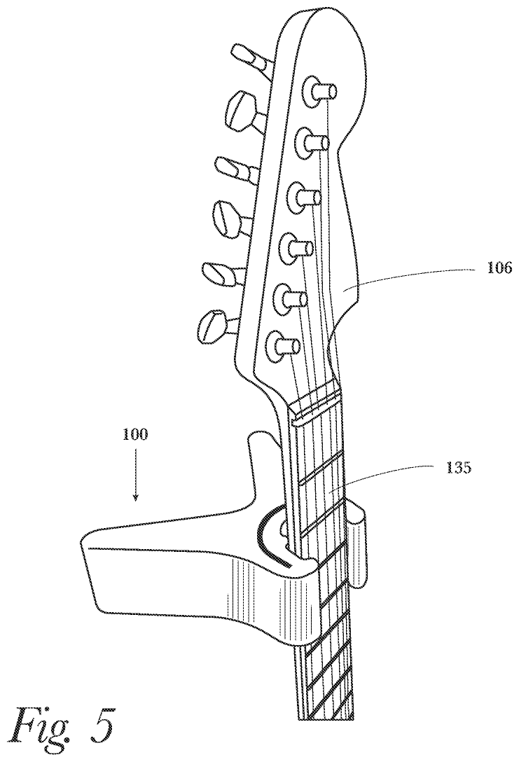

FIG. 5 is a side perspective view of the support device 100 and illustrates the support device 100 positively attached to the neck 135 of a guitar 106. The support device's 100 flexible jaws 105 allow it to be applied to the neck 135 at any point along the length of the neck. As may be understood by one of skill, the neck 135 of a guitar 106 or other stringed instrument typically increases in width from the headstock to the body of the instrument 106. The jaws 105 of the support device 100, being made of a flexible material such as EVA foam, but having sufficient resistance to yield, can open wider to accommodate the neck 135 of the guitar 106 or instrument as the width of the neck 135 gets wider. As is shown in FIG. 5, when attached to the guitar 106, the legs 101 of the support device extend from the back of the neck 135 of the guitar 106 so as to provide support and in the instance where the guitar 106 is leaned against a surface. In this instance, the guitar 106 is leaned against a wall and the legs 101 of the support device 100 act as a stabilizer against the wall so as to prevent the guitar 106 from slipping or sliding with respect to the wall. As may be understood, by providing this support and stabilization, the risk of damage to the guitar 106 is lessened.

In the support device 100 described herein, there are two legs 101 which are separated by about 75 degrees. It should be known that more legs or fewer legs may be used and the degrees of separation between multiple legs may vary depending on the unique configuration. For example, in a configuration where only a single leg is used, the single leg may have an isosceles trapezoid shape, wherein an edge of the leg is configured to abut or rest against the surface and the edge is wider than the jaw 105 portion of the support device 100. Alternatively, more than 2 legs 101 may be used.

As is described above, the support device 100 may be attached to the neck 135 with the legs 101 protruding away from the rear of the support device 100, and consequently, the legs 101 also protrude away from the rear of the neck 135. The legs 101 in a preferred embodiment are approximately 4 inches in length and extend from the back of the jaws 105. The length, shape, and angle of the legs 101 are not limited to those shown in this figure. The legs 101 could be longer or shorter, a different shape, or extend at an angle to the horizontal place of the jaws 105. This embodiment uses a 4-inch leg 101 so that the device is compact enough to be transported easily while still being wide enough to maintain stability. This embodiment uses a tapered leg 101 that is of similar thickness to the jaws 105, though it is not limited to this shape. In another embodiment the legs could be cylindrical, square, rectangular, or other shape. The shape in the preferred embodiment provides more resistance to a shearing force applied by user's hand when squeezing the legs 101 together.

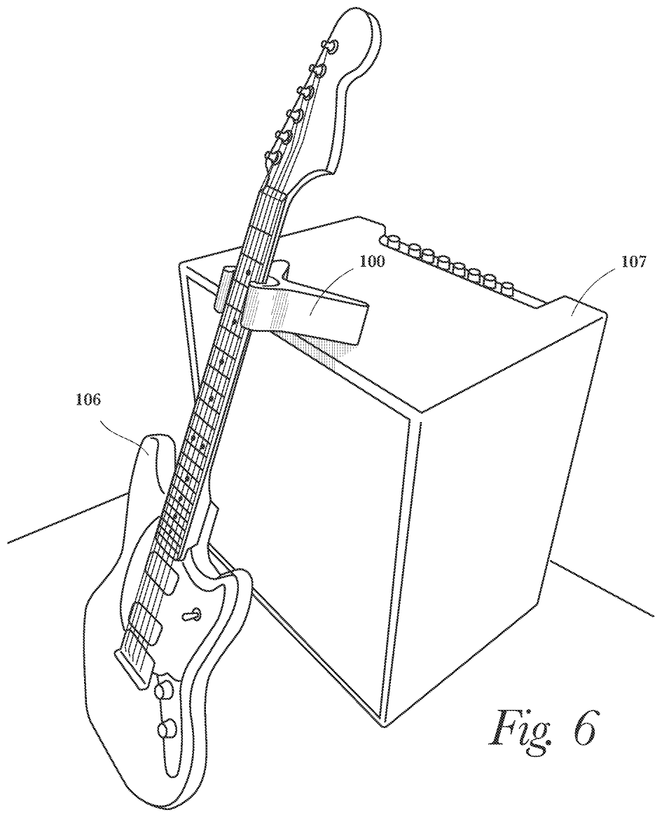

FIG. 6 shows a perspective view of the support device 100 when supporting a guitar 106 against an amplifier 107. In this instance, the surface providing the support to the guitar 106 is a horizontal surface (i.e. the top of the amplifier 107) rather than the vertical surface of the wall shown in FIG. 5. As is shown in each of FIGS. 5 and 6, the support device 100 provides support to the guitar 106 in either application.

More particularly, in the application shown in FIG. 6, the legs 101 may be angled downward in relation to the plane of the neck 135 when in use. The angled legs 101 allow the center of gravity to be lower on the instrument 106 than the point of attachment and thus more stable. In this embodiment the support device 100 could also be positioned at 180 degrees, so the legs are angled upward, allowing the instrument to rest against a surface that is higher than the point of attachment on the neck.

To use the support device 100, a user would grip the neck 135 of a guitar 106, or other stringed instrument, with one hand, and hold the support device 100 in the other hand, then insert one side of the neck 135 of the guitar 106 against one of the longitudinal ridges 104 on the inside of the jaws 105 which protrude into the annular space 115. Then, the user would gently push and twist the neck 135 against the rounded edges 103 on the opposite jaw 105 of the support device 100. This motion will push the jaws 105 apart and allow the neck 135 of the guitar 106 to gently slip inside the jaws 105.

Alternatively, as described above, a user may create an urging force which causes the jaws 105 to further separate by pinching of squeezing the legs 101 together, which in turn creates an opposing force which separates the jaws 105. Additionally, it should be noted that it may not be necessary to apply the squeezing force in order to open the jaws 105. The act of pressing the neck 135 of the instrument 106 into the support device 100 against the rolled edges 103 will also act to open the jaws 105 by applying a force opposite to the spring force 110, and similarly to remove the instrument neck 135 from the support device 100.

Once the neck has 135 cleared the rounded clasp 103, it is prevented from twisting any further by the shape of the rounded longitudinal ridges 104 on the inside of the jaws 105. By expanding the opening of the jaws 105 the support device 100 will impart an equal and opposite force which creates an inward pressure against the sides of the neck 135, thus creating a gripping force which holds the support device 100 to the neck 135 of the instrument 106.

Once the support device 100 has been applied to the neck 135 it may be slid up or down the neck 135 in a vertical direction along the length of the neck 135 to the desired place on the fretboard which corresponds to the height of the object that the instrument 106 is being rested against. For instance, if the guitar 106 were being rested against a common practice amplifier the support device 100 may be positioned around the middle of the fretboard so that when the support device 100 is rested against the amplifier 107 the guitar inclines at a slight degree to the floor thus spreading out the points of contact created by the combination of the legs 101 of the support device 100 and guitar body 106 to create a stable combined entity. The material of the device, which may include but not be limited to any variety of plastic, rubber, foam, or silicone, will have enough surface friction to resist any movement of the neck against the device after it has been applied.

It is important that although in the FIGS. 1-9, the support device 100 is attached to the back of the neck 135, the neck 135 may be inserted into the device either with the fretboard facing outward or inward. The device functions the same in either mode of use. The rounded edges 103 and longitudinal ridges 104 do not harm or alter the strings, fretboard, frets, or neck 135 of the instrument 106.

Further, although the embodiment described above includes a pair of longitudinal ridges 104 which protrude into the annular space, it should be understood that any number of ridges 104 may be used and that the ridges 104 may have a variety of different shapes without departing from the scope of the intended invention.

The support device 100 is removed from the neck 135 of the guitar 106 in much the same manner it was applied, by gently pulling and twisting the neck 135 of the guitar 106 against the rounded edges 103. This motion will expand the jaws 105 and the user can release the neck 135 from the support device 100. Alternately, it is also possible to open or close the support device 100 around an instrument neck 135 by applying an inward squeezing pressure on the legs 101. A user may grasp both legs 101 in one hand and squeeze them together, thus applying a force that would open the jaws 105 wider to assist in the insertion or removal of the instrument 106 from the support device 100.

While the above embodiment describes and illustrates a solid support device 100 made of a homogenous material which may include but not be limited to any type of plastic, silicone, rubber, foam, in another embodiment it may be made of a combination of different materials whose properties, including inelastic materials such as metal, ceramic, or wood, as suits the function of each part of the support device 100. For instance, one embodiment may include an inner spring clip 109 of stiffer material such as metal or ABS plastic, while the outer skin could be a soft pliable rubber or foam so as not to damage the instrument or resting surface. Or in another embodiment the jaws 105 may be made of one material with a higher flexibility than the legs 101 which may be made of a stiffer material.

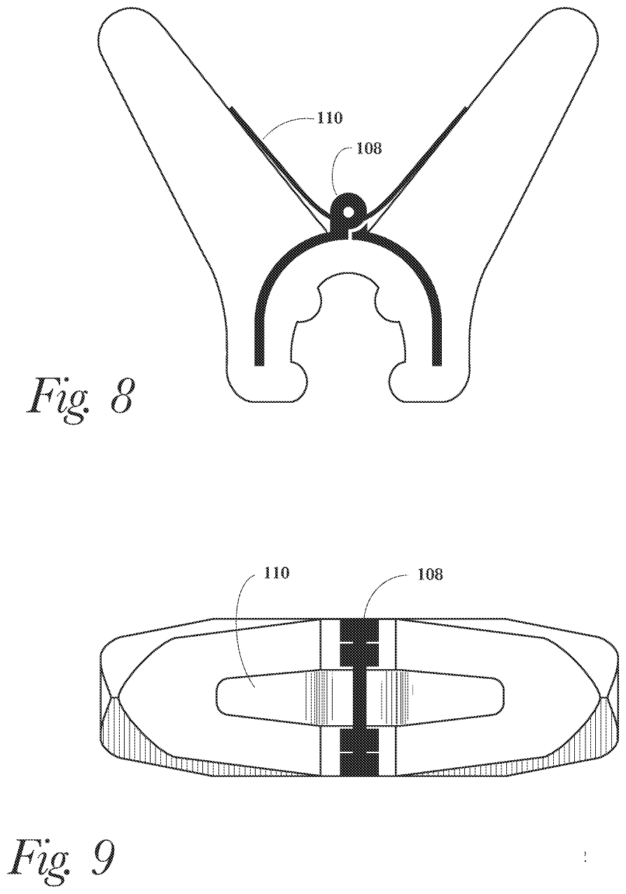

FIGS. 8 and 9 illustrate a second embodiment of the device which uses a hinge 108 at the rear of the jaws 105 to assist in opening and closing. The hinge 108 is assisted by a flat spring 110 or torsion spring which applies force to keep the jaws 105 in the closed position. When the instrument is pushed into the opening of the jaws 105 the hinge 108 can open the jaws 105 wider than they otherwise may be able in the embodiment shown in FIGS. 1 through 7. The ability to open the jaws 105 wider allows the device to accommodate instruments 106 of varying neck sizes and widths. For instance, the width of the neck 135 of an electric guitar 106 near the first fret is much narrower than the width of a five-string electric bass near the 12th fret. The hinged embodiment of the support device 100 could accept a large variety 106 of instruments with a variety of different neck widths.

Like the embodiment of FIGS. 1 through 7, this embodiment could also be opened or closed by squeezing the legs 101 together with one hand. This action would apply a force that would be opposite to the force of the spring 110 and would act to open the jaws 105. When a user ceases to apply this squeezing force then the spring 110 will apply its force inward against the sides of the instrument neck 135. Similarly, to remove the instrument a user can apply the squeezing force to the legs 101 to open the jaws 105 to assist in removing the instrument 106 from the support device 100.

The embodiment depicted in FIGS. 8 and 9 includes a hinged set of jaws 108 and a spring 110 that applies closing pressure against the jaws 108. In this embodiment the spring 110 provides the closing force in lieu of or in addition to the stiffness of the material comprising the support device 100. The hinge 108 and spring mechanism 100 may be similar to those found in common food bag clips. In another embodiment, the hinge 108 may be made of the same material as the inner “C ” shaped spring 109, and the spring 110 could be a blade of bended flat metal, or wire.

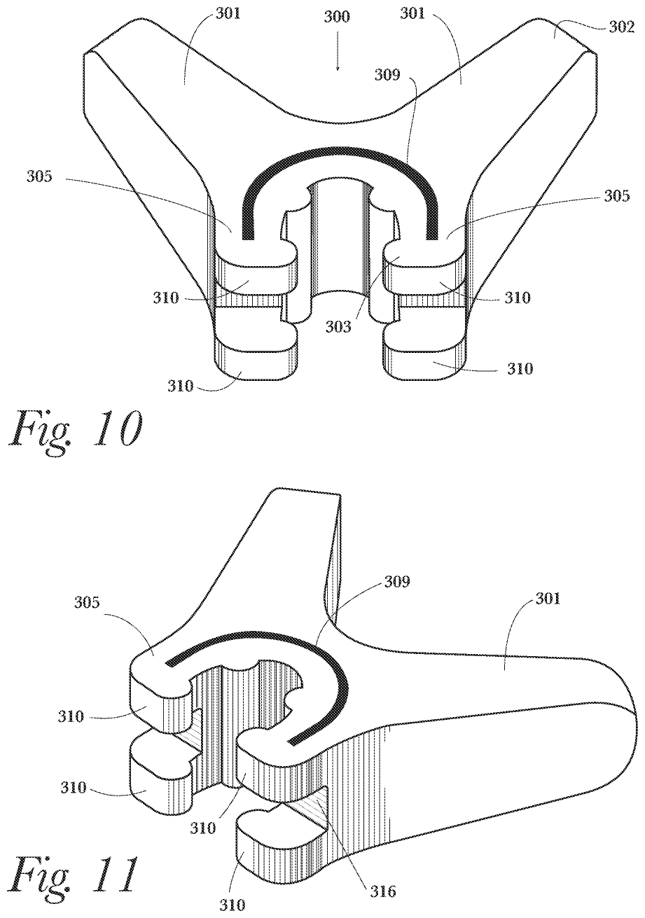

A third embodiment of a support device 300 is shown in FIGS. 10 and 11. FIGS. 10 and 11 show the support device 300 having many of the same characteristics of the support device 100 shown in FIGS. 1-6. Like the embodiment of FIG. 1 through 6, the support device 300 includes jaws 305 to grip the instrument 106. However, the embodiment shown in FIGS. 10-11 the jaws 305 are not continuous along the edge where the rounded edges 303 are formed and instead include a plurality of clasps 310.

More particularly, FIGS. 10-11 illustrate a support device 300 having two clasps 310 per jaw 305 with each clasp 310 located at the top and bottom edge of each jaw 305. This allows a total of four points of contact against the neck 135 to secure the support device 300 of the instrument 106. As may be understood, four points of contact are enough to ensure a snug fit and to resist the overturning force of the guitar 106 against the support device 300 when in use.

In FIGS. 10-11 the four clasps 310 have a semi-circular cutaway 106 that creates two clasps 103 at the top and bottom edge. Though this figure shows a semi-circular cutaway 316, any shape that allows for four clasps 103 to be sufficiently distributed and spaced apart to resist any twisting or overturning force.

Although in the embodiments described above, the legs 101 and 301 are formed as an integral component with the jaw components 105 and 305, other embodiments may be used in association with the claimed invention. For example, the legs 101 may be configured to have a telescoping structure so that the support device can be stored in a compact form that is easier to transport or store when not in use. In such a configuration, the telescoping legs could be made of two or more increasingly larger sections that collapse into one another like a telescope. The telescoping legs could also lock in place when fully or partially extended so that they do not move during use. Another similar embodiment includes legs 101 that fold or collapse against the jaws 105 but that lock when extended and are prevented from collapsing while in use.

The material for manufacturing the embodiments in FIG. 1 through FIG. 9 could include but not be limited to a EVA foam, rubber, plastic, or silicone. In this embodiment the device is cast from a mold with a homogenous outer material of EVA foam and a second material, such as plastic, for the internal spring clip 109. This embodiment is manufactured by overmolding EVA foam over an injection molded internal plastic spring clip. Other suitable materials or combination of materials can be used.

While the invention has been described with reference to specific embodiments, it will be understood by those skilled in the art that various changes may be made, and equivalents may be substituted for elements thereof without departing from the true spirit and scope of the invention. In addition, modifications may be made without departing from the essential teachings of the invention.

Although the invention is illustrated above, partly with reference to some preferred embodiments, it must be understood that numerous modifications and combinations of different features of the embodiments can be made. All of these modifications lie within the scope of the appended claims.

What is claimed is:

1. A support device for a stringed musical instrument, the support device comprising:
a clamping portion formed of a flexible material configured for mounting to a neck of the stringed musical instrument for rigidly holding the neck of the stringed musical instrument prior to placing the stringed musical instrument against a resting surface, the clamping portion including an annular space formed therein for housing the neck of the stringed musical instrument, and having a protruding ridge formed therein configured to prevent the neck or stringed musical instrument from twisting when housed in the annular space; and
two or more support legs connected to a rear of the clamping portion for stabilizing the stringed musical instrument against the resting surface.

2. The support device of claim 1, further comprising a spring clip formed so as to surround a periphery of the clamping portion so as to provide supplemental closing force on the clamping portion.

3. The support device of claim 2, wherein the spring clip has a C or U shape.

4. The support device of claim 2, wherein the spring clip is formed of a different material than the clamping portion.

5. The support device of claim 1, wherein the clamping portion includes two jaw sections, wherein a rounded edge portion is formed at a terminus of each of the jaw sections of the clamping portion for assisting in gripping the neck of the stringed musical instrument when the support device is mounted on the neck of the stringed musical instrument.

6. The support device of claim 5, wherein the clamping portion includes four rounded edge portions, with two rounded edge portions being formed on each jaw section, with a recess being formed between each of the two rounded edge portion formed on each jaw section.

7. The support device of claim 1, wherein the clamping portion and the two or more support legs are formed of a homogenous material including any one of plastic, silicone, rubber, foam, wood, or metal.

8. The support device of claim 1, wherein the clamping portion and the two or more support legs are formed of a combination of materials including any one of plastic, silicone, rubber, foam, wood, or metal.

9. The support device of claim 1, wherein a recess is formed between the two or more support legs and a spring is formed in the recess to provide additional closing force on the clamping portion.

10. The support device of claim 1, wherein the gripping portion and the annular space is configured to receive the stringed musical instrument comprising at least one of a ukulele, an acoustic guitar, an electric guitar, an electric bass guitar, and a six-string guitar.

11. A guitar stand comprising:
a clamping portion formed of a flexible material configured for mounting to a neck of the stringed musical instrument for rigidly holding the neck of the stringed musical instrument prior to placing the guitar against a resting surface, the clamping portion including an annular space formed therein for housing the neck of the guitar, and having a protruding ridge formed therein configured to prevent the neck or guitar from twisting when housed in the annular space; and
two or more support legs connected to a rear of the clamping portion for stabilizing the guitar against the resting surface.

12. The guitar stand of claim 11, further comprising a spring clip formed so as to surround a periphery of the clamping portion so as to provide supplemental closing force on the clamping portion.

13. The guitar stand of claim 12, wherein the spring clip has a C or U shape.

14. The guitar stand of claim 12, wherein the spring clip is formed of a different material than the clamping portion.

15. The guitar stand of claim 11, wherein the clamping portion includes two jaw sections, wherein a rounded edge portion is formed at a terminus of each of the jaw sections of the clamping portion for assisting in gripping the neck of the guitar when the support device is mounted on the neck of the guitar.

16. The guitar stand of claim 15, wherein the clamping portion includes four rounded edge portions, with two rounded edge portions being formed on each jaw section, with a recess being formed between each of the two rounded edge portion formed on each jaw section.

17. The guitar stand of claim 11, wherein the clamping portion and the two or more support legs are formed of a homogenous material including any one of plastic, silicone, rubber, foam, wood, or metal.

18. The guitar stand of claim 11, wherein the clamping portion and the two or more support legs are formed of a combination of materials including any one of plastic, silicone, rubber, foam, wood, or metal.

19. The guitar stand of claim 11, wherein a recess is formed between the two or more support legs and a spring is formed in the recess to provide additional closing force on the clamping portion.

20. The guitar stand of claim 11, wherein the guitar is at least one of an acoustic guitar, an electric guitar, or a six-string guitar.
